(19) United States
(12) Patent Application Publication
(10) Pub. No.: US 2015/0222429 A1
(43) Pub. Date: Aug. 6, 2015

(54) Mutually secure multi-tenant optical data network and method

(71) Applicant: Spada Innovations, Inc., San Diego, CA (US)

(72) Inventors: Joseph L. Vilella, San Diego, CA (US); James R. Reynante, San Diego, CA (US)

(73) Assignee: Spada Innovations, Inc., San Diego, CA (US)

(21) Appl. No.: 14/419,092

(22) PCT Filed: Aug. 2, 2013
(86) PCT No.: PCT/US2013/053389

§ 371 Date: Feb. 2, 2015

Related U.S. Application Data
(60) Provisional application No. 61/678,977, filed on Aug. 2, 2012.

(51) Int. Cl. H04L 9/08; H04B 10/116

(52) U.S. Cl. CPC H04L 9/0852; H04B 10/116; H04L 2209/24

(57) ABSTRACT

A digital optical data network system securely interfaces data traffic between multiple carriers (114,116,118) and multiple end user tenants (102,104,106) of a site such as an office building (100) by accepting multiple carrier data lines (120,122,124) at a common specialized headend (128) for the building, encrypting/decrypting the traffic at the headend, and feeding (130,132,134) the same encrypted optical data feed to each of the multiple private tenants. Each tenant has a specialized encrypting/decrypting optical network unit for extracting and injecting only its data to/from the feed.

### PRIOR APPLICATION

The present application claims the benefit of U.S. Provisional Patent Application Ser. No. 61678977, filed Aug. 2, 2012 incorporated herein by reference.

### FIELD OF THE INVENTION

The instant invention relates to computer networks and more particularly to multi-carrier traffic routing to multiple building tenants.

### BACKGROUND

Nowadays nearly all businesses utilize digital computer networks and benefit from the interconnectivity provided by local and wide area networks, and connection to the Internet. Many businesses have many types of devices connected to the network including personal computers, wireless controllers, application servers, printers, scanners, and television sets. The digital signals carried by the network can include converged voice, data and video signal content traffic.

Many businesses send and receive digital information which is intended to remain private and can be confidential to the individual business. Such businesses can be located in the same office building as co-tenants. In the past, reasonable privacy can be accomplished by each tenant business connecting directly to a secure service provider carrier using a dedicated headend located in the tenant space including a modem, workgroup switches and routing equipment. This equipment typically requires its own cooling equipment. Often the connection throughout the local network and to the carrier is through copper wiring which, due to its electrical resistance, can generate additional heat requiring cooling. All this equipment and cooling capability is often multiplied by the number of individual tenants in a building, leading to high power consumption.

A typical limiting factor using copper wiring for digital connection lines is bandwidth. Thus, a particular business tenant may elect to upgrade its individual local network and its connection to the carrier using high bandwidth equipment. Increasing the bandwidth often requires additional copper wiring, and more air conditioning.

With the development of optical fiber technology, photonic networks promise significantly higher bandwidth and lower power consumption. However, replacing a business tenant's existing copper based local area network equipment with optical equipment is not economically feasible.

The instant invention results from efforts to provide an improved multi-tenant networking system which addresses one or more of the above problems.

### SUMMARY

The primary and secondary objects of the invention are to provide an improved multi-tenant networking system. These and other objects are achieved by providing a specialized headend encrypting/decrypting aggregation unit feeding an encrypted optical data feed to each user, and providing a specialized encrypting/decrypting optical terminal device at each user for extracting and injecting the end user's data to/from the feed.

In some embodiments there is provided a digital data network communication method comprises: accepting a plurality of private data streams serving a plurality of private tenants; encrypting each of said streams; aggregating said encrypted streams into a combined encrypted data feed; optically routing said encrypted data feed to at least two of said plurality of private tenants; extracting from said encrypted data feed a first one of said private data streams; wherein said extracting comprises: partially decrypting said encrypted feed.

In some embodiments said encrypting each of said streams comprises: encrypting informational data; encrypting telephone data; and, encrypting video data.

In some embodiments said accepting comprises: interfacing a plurality of service provider data lines through a single headend.

In some embodiments said interfacing comprises: utilizing a premise router and a radio frequency video converter; and, feeding an output of said premise router through an optical line terminal.

In some embodiments said interfacing further comprises: feeding an output of said converter through said optical line terminal.

In some embodiments said optically routing comprises: sending said encrypted data feed through an optical splitter.

In some embodiments said encrypted data feed comprises: a plurality of encrypted ethernet frames; wherein a subset of said frames are associated with a first one of said tenants and a second subset of said frames is associated with a second one of said tenants.

In some embodiments said extracting comprises: operating an optical network unit at each of said tenants; wherein said operating comprises: decrypting incoming intended data packets from said feed; not decrypting incoming unintended data packets from said feed; and, encrypting outgoing data packets to said feed.

In some embodiments said aggregating comprises using an enterprise aggregating switch.

In some embodiments there is provided a multi-tenant optical data network comprises: a plurality of network service carrier lines connected to a premise router; at least one uplink connecting said premise router to an optical line terminal; said optical line terminal being connected to a number of feeder passive optical network feeds for carrying a common encrypted data feed to a plurality of optical network units each supporting at least one of a plurality of private tenant devices; and, wherein each of said optical network units is adapted to extract data packets intended for a supported one of said devices.

### BRIEF DESCRIPTION OF THE DRAWINGS

FIG. 1 is a functional block diagram of several data service providers supplying multi-tenant building through a single headend according to an exemplary embodiment of the invention.

FIG. 2 is a functional block diagram of main point of entry room for the data network servicing a multi-tenant building according to an exemplary embodiment of the invention.

FIG. 3 is a functional block diagram for a premise router according to an exemplary embodiment of the invention.

FIG. 4 is a functional block diagram of an optical line terminal servicing multiple tenants with a common data feed according to an exemplary embodiment of the invention.

FIG. 5 is a functional block diagram of an optical line terminal aggregating data and video streams into a common optical data feed according to an exemplary embodiment of the invention.

FIG. 6 is a functional block diagram of an optical network unit interfacing a tenant private network with a common optical data feed according to an exemplary embodiment of the invention.

### DESCRIPTION OF THE EXEMPLARY EMBODIMENTS

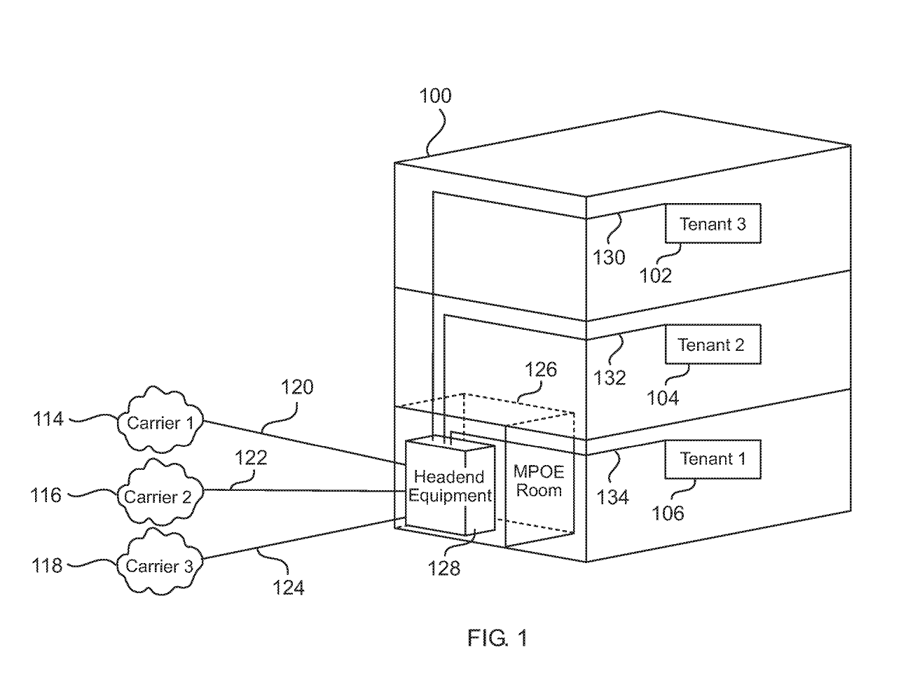

Referring now to the drawing, there is illustrated in FIGS. 1-6 the components of a system 1 used to provide a mutually secure, shared Local Area Network (“LAN”) implementation which can supply a multi-tenant site such as an office building 100 with converged voice, data and video signal content traffic at gigabit speeds to a plurality of mutually secure end point users such as building tenants having multiple end user devices such as computers, access points and wireless controllers, application servers and printers, and television sets.

As shown in FIG. 1, a single building 100 can have multiple tenants 102, 104, 106 such as individual companies, each potentially having multiple digital network devices. The system offers each tenant the ability to specify and use their own private address space even if the data feed overlaps with neighboring tenant on the same network, and the transmission of converged content traffic over the shared infrastructure while maintaining the separation and security of the individual tenant content traffic.

The system relies upon a collection of standards-based technologies that are designed and implemented to provide a point-to-multipoint networking through a single aggregation switch that is capable of providing thousands of IP voice, data, and video connection ports.

In a basic configuration, the aggregate downstream rate can be 2.5 Gbps, while the upstream rate can be 1.25 Gbps. Each of the connections can be adapted to support high-bandwidth multimedia applications on a single optical fiber over a distance of 20 km or more. Telecommunications service traffic that includes Internet, public switched telephone networks, and broadcast/cable television 108, 110, 112 for the building are provided by one or more commercial carriers 114, 116, 118. The telecommunications services carrier lines 120,122,124 enter the building 100 at a Main Point Of Entry (MPOE) room 126 and terminate into headend equipment 128. From the headend equipment, the voice, video and data content traffic can distributed to each of the tenants 102, 104, 106 over data feeds carried by fiber optic cabling 130, 132, 134.

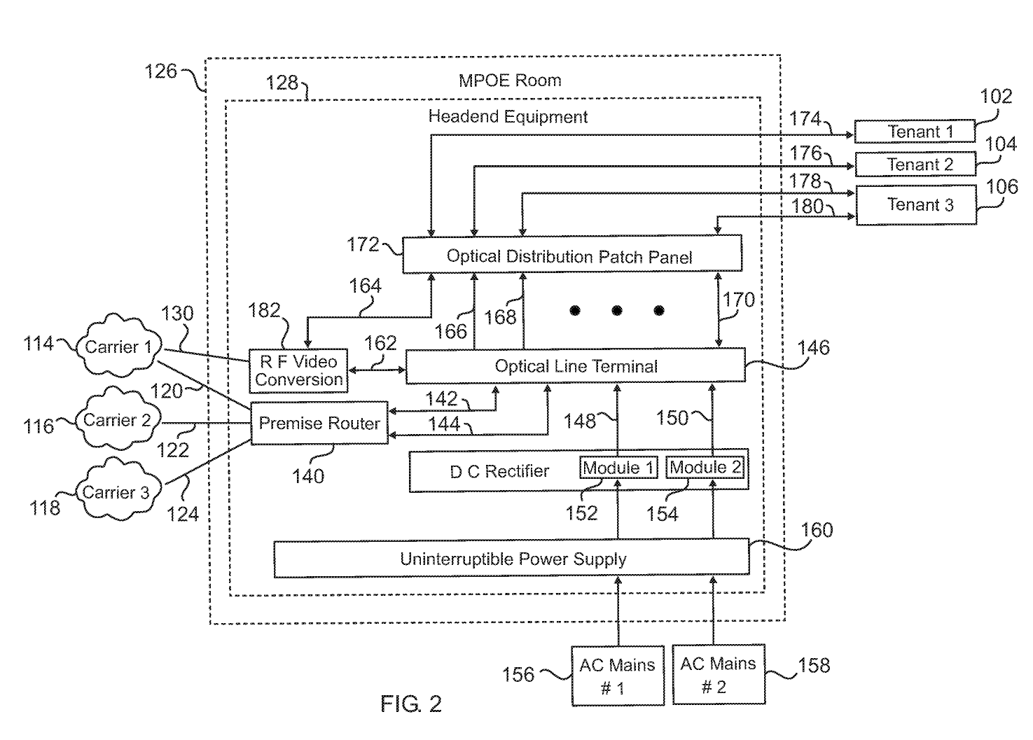

As shown in FIG. 2, the secure, shared multi-tenant LAN architecture can include a premise router 140, an aggregation switch referred to as an Optical Line Terminal (OLT) 146, a plurality of end user terminal devices such as computers, telephones and televisions located within the physically separate tenant 102, 104, 106 spaces, and an optical distribution network that consists of splitters and fiber cabling infrastructure.

The headend equipment 128 receives the plurality of telecommunications service carrier lines 120,122,124 from the separate carrier providers 114, 116, 118. An RF-based video signal can be supplied by one or more of the carriers to the headend equipment via a broadband coaxial cable 130. The interface to the carrier lines within the headend equipment is the premise router 140. The premise router is configured with Virtual Routing and Forwarding (VRF) as described in RFC 4381 and RFC 4382, and utilizes Virtual Local Area Network (VLAN) tagging to separate and manage the distribution of the voice, video and data content traffic. The VLAN-tagged voice, video, and data content traffic is connected to the Optical Line Terminal (OLT) 146 through an uplink 142 that provides primary communication. Optionally, a secondary uplink 144 may be employed as a backup communication path.

The OLT 146 can be powered by dual 48 VDC power feeds 148, 150 from rectifier modules 152, 154 that are attached to separate AC Mains 156, 158 through an uninterruptible power supply 160.

The OLT 146 takes the VLAN-tagged voice, video, and data content traffic 142, 144 and processes each of the ethernet frames by encrypting them, converting them into light, and outputting them as a photonic broadcast stream to the appropriate initial feeder Passive Optical Network (PON) 162, 164, 166, 168, 170 that connects to an optical distribution patch panel 172. The optical distribution patch panel 172 is used to provide the ability for cross-connecting the initial feeder PONs 162, 164, 166, 168, 170 to the distribution feeder PONs 174, 176, 178, 180 that traverse the distance to the remotely located tenants 102, 104, 106. A tenant 106 requiring larger bandwidth can accept multiple distribution feeder PONs 178, 180.

In the case where a carrier provider 114 supplies an RF-based video signal 130, the headend equipment 128 receives the RF-based video signal and converts it into light by processing the electrical analog signal and using it to modulate a laser which outputs the equivalent video photonic stream. This new video photonic stream is then combined with an initial feeder PON 162 which results in a modified initial feeder PON 164 that contains a photonic broadcast stream that contains the voice, video and data content traffic that is then fed into the optical distribution patch panel 172.

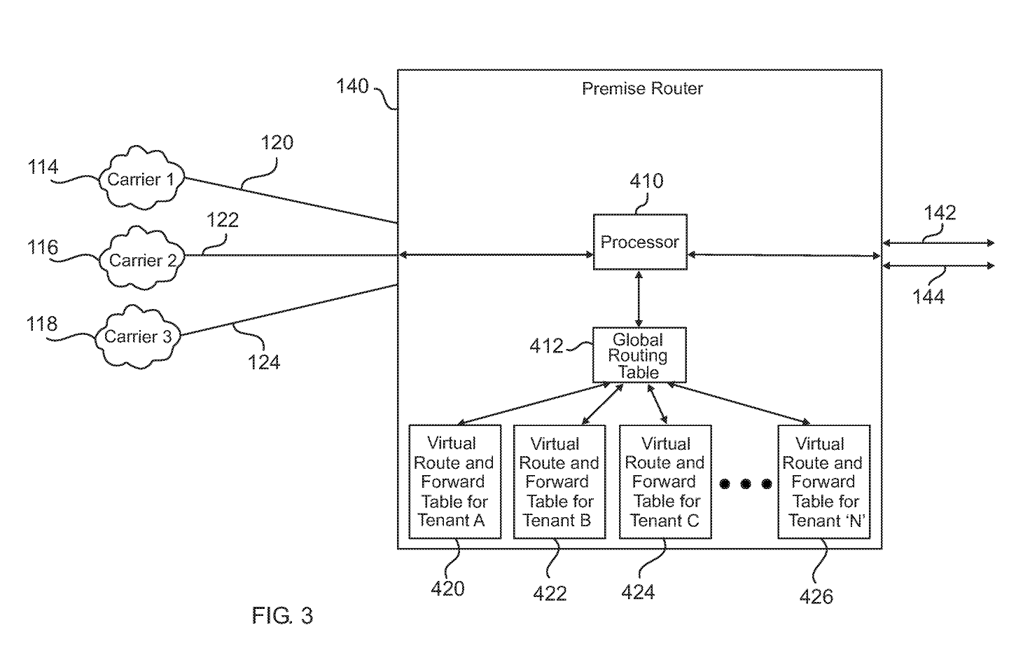

As shown in FIG. 3, the premise router 140 can be the interface to each of the commercial carrier providers 114, 116,118 through either a packet-switched or a leased-line Wide Area Network (WAN) interface in order to utilize the telecommunications services provided over carrier lines 120,122,124. Logical circuits can make connections between the premise router 140 and carrier providers 114, 116, 118, utilizing a shared-bandwidth connection that may be shared with other carrier customers and could potentially affect quality of service and bandwidth availability. The leased-line connection provides a direct interface access to the carrier and eliminates the possibility of being affected by other carrier customers. The premise router 140 can be configured with a global routing table 412 that accesses the Virtual Routing and Forwarding (VRF) table instantiations 420, 422, 424, 426 for each tenant. The VRF capability allows creation of multiple routing tables, one for each tenant, within the single premise router 140. This capability supports the overlapping of IP addresses for any of the tenants because the routing instances are independent.

Thus, the premise router processor 410 gets and puts the tenant-specific routing information in the global routing table 412 which in turn reads and updates the appropriate VRF tables 420, 422, 424, 426. The updated VRF tables are used to uniquely VLAN-tag the voice, video, and data content traffic that is sent and received through the uplinks 142, to the OLT 146.

In this way, the overlapping IP address on a single Passive Optical Network infrastructure allows each tenant connected to the infrastructure to transmit and receive information to any of the carriers. Thus all the tenants in a building can simply connect to the Passive Optical Network infrastructure without the need for their own dedicated headend.

A configuration file loaded into the premise router contains the commands to implement the virtual route and forwarding capability is shown below. Comment lines begin with the following string: !- - -

```
!
version 12.2
!
hostname Spada
!
ip cef
!
!--- Tenant A commands.
ip vrf Tenant_A
!--- Enables the VPN routing and forwarding VRF routing table.
!--- This command can be used in global or
!--- router configuration mode.
  rd 100:110
!--- Route distinguisher creates routing and forwarding
!--- tables for a VRF.
  route-target export 100:1000
!--- Creates lists of import and export route-target extended
!--- communities for the specified VRF.
  route-target import 100:1000
!
!--- Tenant B commands.
ip vrf Tenant_B
  rd 100:120
  route-target export 100:2000
  route-target import 100:2000
!
interface Loopback0
  ip address 10.10.10.4 255.255.255.255
  ip router isis
!--- Tenant A commands.
interface Loopback101
ip vrf forwarding Tenant_A
!--- Associates a VRF instance with an interface or subinterface.
  ip address 200.0.4.1 255.255.255.0
!--- Loopback101 and 102 use the same IP address, 200.0.4.1.
!--- This is allowed because they belong to two
!--- different Tenants' VRFs.
  no ip directed-broadcast
!
!--- Tenant B commands.
interface Loopback102
  ip vrf forwarding Tenant_B
  ip address 200.0.4.1 255.255.255.0
!--- Loopback101 and 102 use the same IP address, 200.0.4.1.
!--- This is allowed because they belong to two
!--- different Tenants' VRFs.
  no ip directed-broadcast
!
interface Serial2/0
  no ip address
  no ip directed-broadcast
  encapsulation frame-relay
  no fair-queue
!
interface Serial2/0.1 point-to-point
  description link to Pauillac
  bandwidth 512
  ip address 10.1.1.14 255.255.255.252
  no ip directed-broadcast
  ip router isis
  tag-switching ip
  frame-relay interface-dlci 401
!
router isis
  net 49.0001.0000.0000.0004.00
  is-type level-1
!
router bgp 100
  bgp log-neighbor-changes
!--- Enables logging of BGP neighbor resets.
  neighbor 10.10.10.6 remote-as 100
!--- Adds an entry to the BGP or multiprotocol BGP neighbor table.
  neighbor 10.10.10.6 update-source Loopback0
!--- Enables BGP sessions to use a specific operational
!--- interface for TCP connections.
!--- Tenant A and B commands.
  address-family vpnv4
!--- To enter address family configuration mode
!--- for configuring routing sessions, such as BGP,
!--- that use standard VPN version 4 address prefixes.
  neighbor 10.10.10.6 activate
  neighbor 10.10.10.6 send-community both
!--- Sends the community attribute to a BGP neighbor.
  exit-address-family
  !
!--- Tenant B commands.
  address-family ipv4 vrf Tenant_B
!--- To enter address family configuration mode
!--- for configuring routing sessions, such as BGP,
!--- that use standard VPN version 4 address prefixes.
  redistribute connected
  no auto-summary
  no synchronization
  exit-address-family
  !
!--- Tenant A commands.
  address-family ipv4 vrf Tenant_A
  redistribute connected
  no auto-summary
  no synchronization
  exit-address-family
!
ip classless
!
end
```

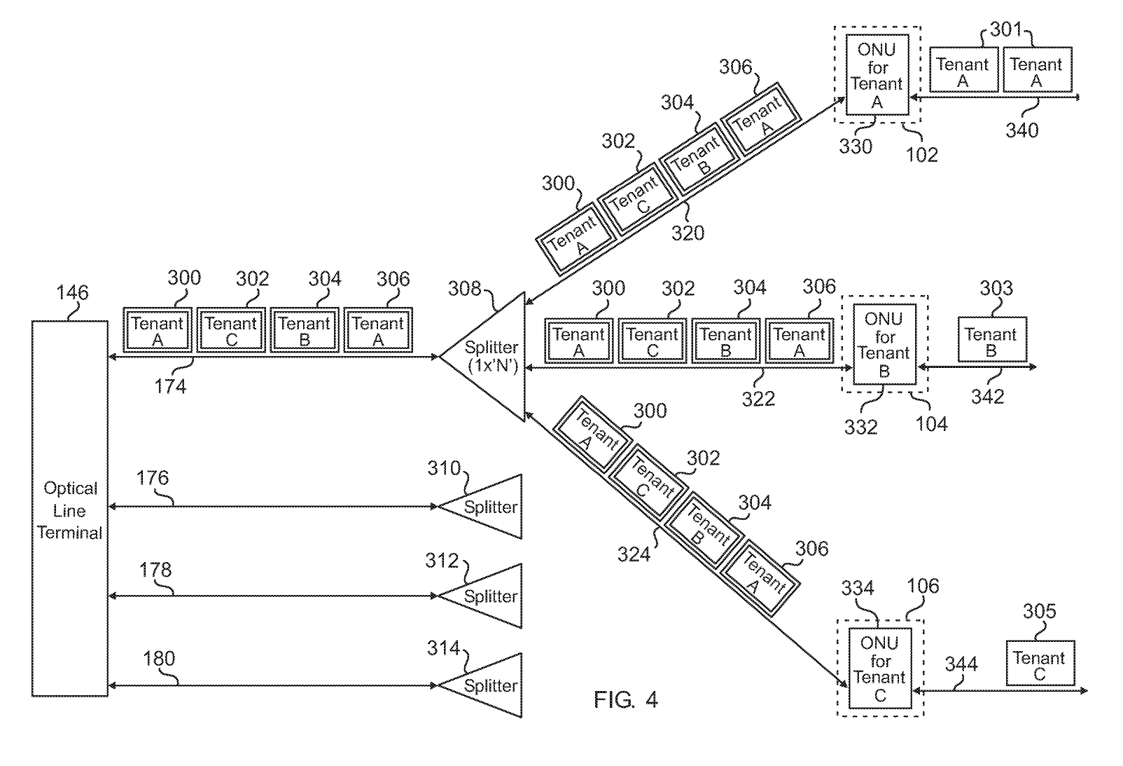

As shown in FIG. 4 represents the Passive Optical Network infrastructure is optical distribution network used to convey the photonic broadcast stream feeds that contains the encrypted data packets such as VLAN-tagged ethernet frames 300, 302, 304, 306 that are distributed back and forth between the various tenant spaces 102, 104, 106 and the OLT 146. Essentially, the OLT can broadcast the combined encrypted VLAN-tagged ethernet frames 300, 302, 304, 306 over the distribution feeder PONs 174, 176, 178, 180 to a number of splitters 308, 310, 312, 314.

Each splitter 308 can replicate the incoming photonic broadcast stream equally over each of it's drop PONs 320, 322, 324. The splitter 308 can attach to the simplex, single-mode fiber from the OLT 146 and can passively redistribute the incoming light stream up to 64 times. The splitter is a Planar Lightwave Circuit (PLC) that is constructed using silica glass waveguide circuits and aligned fiber optic pigtails that are all integrated inside of a single package. The attenuation of the light signal through the PLC of the splitter 308 is symmetrical in both directions. The signal loss from a 1×8 PLC splitter is expected to be less than one dB greater than what would be expected from a perfect splitter, approximately 10 dB. A typical 1×32 PLC splitter shall have approximately 17 dB or less.

Each of the outputs from the optical splitter can be an individual simplex, single-mode fiber called a drop PON 320, 322, 324. The drop PONs can be routed and fed into the appropriate tenant physical space 102, 104, 106 and terminated into the tenant's dedicated Optical Network Unit (ONU) 330, 332, 334.

Each ONU 330, 332, 334 is operated so that it utilizes the VLAN-tagging to select those of the incoming ethernet frames assigned to the particular tenant, and then removes the encryption from the selected ethernet frames. Thus, each ONU strips out or extracts only those incoming frames that are intend for the particular tenant. The decrypted ethernet frames 301, 303, 305 are then made available 340, 342, 344 for the tenant's IP/ethernet end-user equipment. Those frames not assigned to the particular tenant are ignored and cannot be decrypted by the particular tenant. In other words, a first subset of the frames can be associated a first piece of end-user equipment and a second subset of the frames is associated with a second piece of end-user equipment. The first and second pieces of equipment can be common to a single tenant or can be split among separate tenants.

In other words, for example, tenant A 102 gets supplied to its ONU 330 all incoming encrypted frames 300, 302, 304, 306 via its drop PON 320 including those frames that are intended for it 300,306 and those frames that are unintended for it 302, 304. The ONU strips out its intended encrypted frames 300, and 306 and decrypts them to form its intended decrypted frames 301 which it makes available to Tenant A's dedicated, private data line 340. The ONU also encrypts outgoing frames.

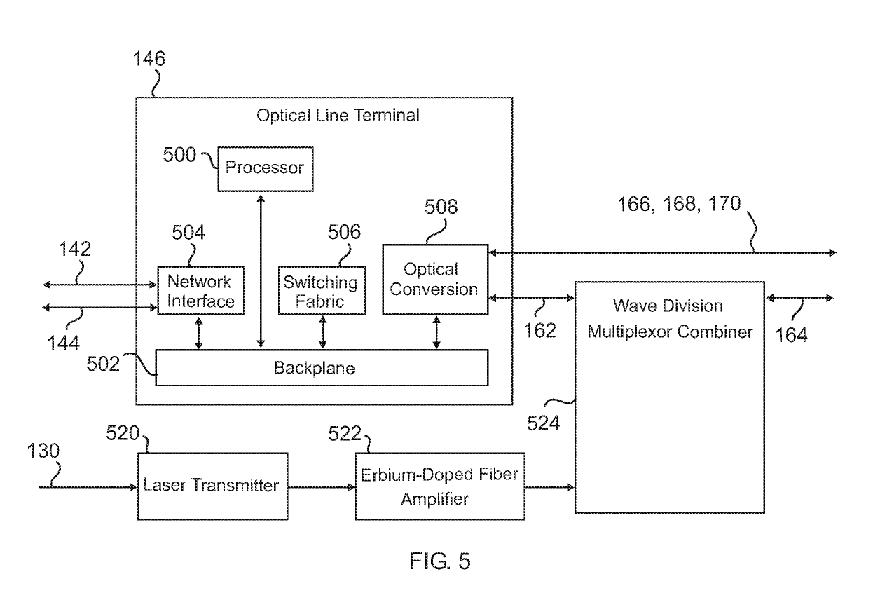

As shown in FIG. 5, the OLT 146 that typically resides in the MPOE room 126 can be a key component of the headend equipment 128. The OLT 146 can perform as the Layer-2 workgroup switching mechanism for voice, video and data content traffic that is sent and received from the individual tenants.

The OLT 146 equipment can be a chassis having multiple slots used to host circuit boards that perform various functions. Operations of the OLT are managed and controlled by a processor 500. A backplane 502 of the OLT can provide the communication path for all of the control, management, and data signals between the circuit boards installed within the OLT. A network interface 504 provides the interface to/from the primary uplink 142 and backup uplink 144 connections to the premise router 140. A switching fabric component 506 can be used to encrypts the VLAN-tagged ethernet frames using the appropriate symmetric key for a specific tenant and sends the result to an optical conversion component 508 for transmission to the tenant. The content traffic on the switching fabric component 506 is encrypted for each tenant location before being transmitted over the shared optical distribution network. Encryption of the layer-2 ethernet frames is used to provide the confidentiality of each tenant's signal traffic.

A symmetric-key algorithm can be used for the encryption of the ethernet frame data packets. This particular implementation utilizes a fixed block size of 128-bits and a key size of 128-bits that operate on a 4×4 column-major order matrix of bytes. It performs 10 cycles of transformation rounds that convert the input plaintext into the final output of ciphertext. Each round can consists of:

a. First, a byte substitution function is performed where each byte in the state matrix is replaced using an 8-bit substitution.

b. Next, each of the rows of the state are shifted by a certain number of steps. The first row is left unchanged. Each byte of the second row is shifted one to the left. Similarly, the third and fourth rows are shifted by offsets of two and three respectively. Row n is shifted left circular by n-1 bytes.

c. Finally, the columns of the state are mixed by combining the four bytes in each column. The four bytes of each column of the state are combined using linear transformation. Encryption is used to specifically prevent man-in-the-middle attacks. Additionally, the PON configuration also supports IEEE 802.1x authentication in order to provide provide port based Network Access Control to limit network access, with features like IP//MAC address limiting to secure the network from unauthorized/malicious users.

The optical conversion component 508 of the OLT 146 can convert the electrical signals of the encrypted VLAN-tagged ethernet frames and output them over the initial feeder PONs 162, 166, 168, 170 as modulated optical signals.

In the case where a carrier provider 114 supplies an RF-based video signal 130 to the headend equipment 128, the signal is connected to a laser transmitter 520 where the input broadband signal is used to modulate a laser. The modulated output of the laser is a low-level photonic light stream. The photonic light stream is sent to an erbium-doped fiber amplifier 522, where the signal is increased to approximately 30 dBmV. The resulting amplified video signal is then overlayed on an initial feeder PON 162 through the use of a wave division multiplexor combiner 524. The output from the wave division multiplexor combiner 524 is a feeder PON 164 that contains encrypted VLAN-tagged ethernet frames and a laser-modulated, RF-based video signal.

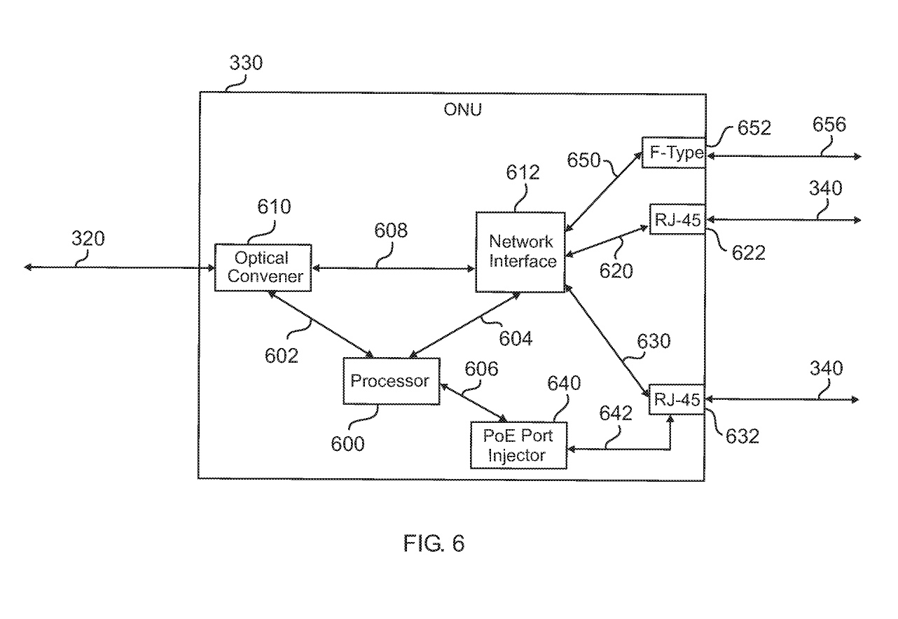

As shown in FIG. 6, each tenant can have one or more of an ONU 330 that accepts drop PON 320 connections. The ONU 330 terminates optical fibers from a splitter 308 and sends/receives decrypted ethernet frames 340 to the tenant's IP/ethernet equipment, and RF video signals 656 to the tenant's television. The ONU has a processor 600 which controls and manages all activity of the ONU by directly communicating all of the control and management signals 602, 604, 606 to/from its internal components 610, 612, 640. The ONU receives the photonic light stream transmitted over the drop PON 320. The optical converter 610 examines the encrypted photonic light stream that enters the component. If the VLAN-tagged ethernet frame has been encrypted with the same symmetric key, it indicates that the VLAN-tagged frame belongs to the tenant of that ONU. After the optical converter 610 performs the decryption, the VLAN-tagged ethernet frame is sent to the network interface 612 of the ONU via the direct communication path 608. The network interface 612 demultiplexes the electrical signal to divide out baseband telephony/data signals from broadband video channels. The network interface sends/receives the VLAN-tagged ethernet frames to the appropriate physical connection interface 622, 632, 652. The ONU can supply a basic 802.3 ethernet interface 622, or an 802.3 ethernet interface that include power-over-ethernet (PoE) capability 632, or an RF-based video F-Type interface 652 to transmit the RF-based video signal 656. The PoE port injector 640 implements the Power-Over-Ethernet and Power-Over-Ethernet Plus based upon the IEEE 802.3af-2003 and IEEE 802.3at-2009 standards respectively.

In this way, the above described system empowers a multi-tenant building 100 with an environment to securely host individual tenant data traffic with overall network flexibility. This ability of the system allows it to leverage the high bandwidth and energy efficiency of passive optical network equipment for the entire building. Because optical bandwidth is comparatively unlimited, existing systems often do not utilize this capacity. Thus, the high bandwidth capability of optical fiber can be leveraged to route all traffic optically and uniformly throughout the building on an aggregated feed. Each tenant can extract its share of the traffic from the feed. In this way, a single headend having reduced air conditioning requirements can be located at the building's main pint of entry, and no additional air conditioning is needed at the individual tenant spaces for what would have been headend-type network equipment.

While the preferred embodiment of the invention has been described, modifications can be made and other embodiments may be devised without departing from the spirit of the invention and the scope of the appended claims.

What is claimed is:

1. A digital data network communication method comprises:
accepting a plurality of private data streams serving a plurality of private tenants;
encrypting each of said streams;
aggregating said encrypted streams into a combined encrypted data feed;
optically routing said encrypted data feed to at least two of said plurality of private tenants;
extracting from said encrypted data feed a first one of said private data streams;
wherein said extracting comprises:
partially decrypting said encrypted feed.

2. The method of claim 1, wherein encrypting each of said streams comprises:
encrypting informational data;
encrypting telephone data; and,
encrypting video data.

3. The method of claim 1, wherein said accepting comprises:
interfacing a plurality of service provider data lines through a single headend.

4. The method of claim 3, wherein said interfacing comprises:
utilizing a premise router and a radio frequency video converter; and,
feeding an output of said premise router through an optical line terminal.

5. The method of claim 4, wherein said interfacing further comprises:
feeding an output of said converter through said optical line terminal.

6. The method of claim 3, wherein said optically routing comprises:
sending said encrypted data feed through an optical splitter.

7. The method of claim 1, wherein said encrypted data feed comprises:
a plurality of encrypted ethernet frames;
wherein a subset of said frames are associated with a first one of said tenants and a second subset of said frames is associated with a second one of said tenants.

8. The method of claim 1, wherein said extracting comprises:
operating an optical network unit at each of said tenants;
wherein said operating comprises:
decrypting incoming intended data packets from said feed;
not decrypting incoming unintended data packets from said feed; and,
encrypting outgoing data packets to said feed.

9. The method of claim 1, wherein said aggregating comprises using an enterprise aggregating switch.

10. A multi-tenant optical data network comprises:
a plurality of network service carrier lines connected to a premise router;
at least one uplink connecting said premise router to an optical line terminal;
said optical line terminal being connected to a number of feeder passive optical network feeds for carrying a common encrypted data feed to a plurality of optical network units each supporting at least one of a plurality of private tenant devices; and,
wherein each of said optical network units is adapted to extract data packets intended for a supported one of said devices.
